(19) United States
(12) Patent Application Publication
(10) Pub. No.: US 2005/0104456 A1
(43) Pub. Date: May 19, 2005

(54) Electromagnetic actuator

(75) Inventors: Hisashi Yajima, Tsukuba-gun (JP); Nobuhiro Fujiwara, Tsukuba-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SMC Corporation, Tokyo (JP)

(21) Appl. No.: 10/921,946

(22) Filed: Aug. 20, 2004

(30) Foreign Application Priority Data
Nov. 13, 2003 (JP) 2003-384047

(51) Int. Cl. H02K 41/00

(52) U.S. Cl. 310/14; 310/12

(57) ABSTRACT

An electromagnetic actuator comprises: a fixed core of a magnetic material provided with one pair of pole teeth, which are cylindrical and face each other; exciting coils wound on the fixed core; and a moving object which is movably disposed in the direction of the axis line coaxially with the pole teeth, wherein the moving object includes: cylindrical permanent magnet, in which the N pole and the S pole have been magnetized in the radial direction; and a cylindrical movable core of magnetic material which is coaxially connected to the permanent magnet and is displaced together with the permanent magnet.

### TECHNICAL FIELD

The present invention relates to an electromagnetic actuator which drives a moving object in a straight line, using a magnetic force generated at application of direct voltage.

### BACKGROUND ART

Such a linear electromagnetic actuator which drives a moving object in a straight line, using a magnetic force generated at application of direct voltage, has been known as, for example, VCM, a solenoid, and the like so far. Generally, this kind of electromagnetic actuator has a limited stroke, and cannot obtain a large stroke unlike a rotary motor. The reason is that the larger stroke causes more reduced thrust.

On the other hand, an electromagnetic actuator using a permanent magnet as a moving object has been disclosed in Japanese Patent Application Laid-open No. 7-94323 (JP-A) and JP-A No. 2002-101631. When a permanent magnet is used as a moving object like the above actuator, the actuator can generate a larger thrust with low voltage than that of an actuator with a moving object which is formed of a magnetic material, though the magnetic material becomes magnetized only when a magnetic force is applied, and a larger stroke can be obtained along with the larger thrust. Especially, as a magnetic reluctance is reduced and a magnetic attraction force is increased by forming a part of a magnetic path with a back yoke when the back yoke is provided and fixed at a position adjacent to the permanent magnet as described in JP-A No. 2002-101631, the further larger thrust than that of an actuator without the back yoke can be realized.

However, a further improved actuator is desired because a further larger thrust is needed in some cases, depending on the use of an electromagnetic actuator.

### SUMMARY OF THE INVENTION

The object of the present invention is to provide an electromagnetic actuator which uses a permanent magnet as a moving object, and is configured to realize a larger thrust.

In order to achieve the above-described object, an electromagnetic actuator of the present invention comprises: a fixed core of a magnetic material provided with one pair of cylindrical pole teeth, which coaxially face each other through a gap; exciting coils wound on the fixed core; and a moving object which is movably disposed in the direction of the axis line coaxially with the electromagnet, wherein the moving object includes: one or more cylindrical permanent magnets formed integrally in a cylindrical shape or formed by cylindrically disposing a plurality of magnet pieces of arc-shaped cross section, in which the N pole and the S pole have been magnetized in the radial direction; and a cylindrical movable core of a magnetic material which is coaxially connected to the permanent magnet and is displaced together with the magnet.

According to one aspect of the present invention, the pair of pole teeth in the fixed core are provided on the inner peripheral side of the exciting coils; the moving object is fitted into the inside of the pole teeth; and the permanent magnet is connected to the moving object so that the permanent magnet faces the pole teeth on the outer periphery of the movable core.

According to another aspect of the present invention, the pair of pole teeth in the fixed core are provided on the outer peripheral side of the exciting coils; the moving object is fitted into the outside of the pole teeth; and the permanent magnet is connected to the moving object so that the permanent magnet faces the pole teeth on the inner periphery of the movable core.

In the present invention, the axial length of the permanent magnet is shorter than the disposition length of the pair of pole teeth, and the axial length of the movable core is longer than either of the length of the permanent magnet or the disposition length of the pair of pole teeth.

According to further another aspect of the present invention, the moving object has one permanent magnet; a concave groove in the circumferential direction is formed on the movable core so that the groove faces the pole teeth; the permanent magnet is fitted into the concave groove; and the circumferential surface of the permanent magnet, and that of the movable core, which face the pole teeth, are located on the same circumferential surface.

According to yet another aspect of the present invention, the moving object comprises two kinds of permanent magnets which are different from each other in the direction of magnetization for the N pole or the S pole, and the two kinds of permanent magnets are plurally alternately disposed in the direction of the axis line.

In this case, preferably, the moving object has three permanent magnets, and the total length of the plurality of permanent magnets and the length of the movable core are substantially the same.

An electromagnetic actuator according to the present invention can obtain a larger thrust, by combining a permanent magnet and a core for forming a moving object, than that of a conventional electromagnetic actuator in which a moving object is formed only with a permanent magnet.

### BRIEF DESCRIPTION OF THE DRAWINGS

FIG. 1 is a cross sectional view showing a principle of a linear electromagnetic actuator according to a first embodiment of the present invention;

FIG. 2 is a view showing a magnetic equivalent circuit of the electromagnetic actuator shown in FIG. 1;

FIG. 3 is a circuit view showing a non-energized state of the magnetic equivalent circuit shown in FIG. 2;

FIG. 4 is a circuit view showing a simplified circuit for the circuit in FIG. 3;

FIG. 5 is a circuit view showing an energized state of the magnetic equivalent circuit shown in FIG. 2;

FIG. 6 is a circuit view showing a simplified circuit for the circuit in FIG. 5;

FIG. 7 is a cross sectional view showing a principle of a linear electromagnetic actuator according to a second embodiment of the present invention;

FIG. 8 is a cross sectional view showing a principle of a linear electromagnetic actuator according to a third embodiment of the present invention;

FIG. 9 is a view showing a magnetic equivalent circuit of the electromagnetic actuator shown in FIG. 8;

FIG. 10 is a cross sectional view showing a principle of a linear electromagnetic actuator according to a fourth embodiment of the present invention;

FIG. 11 is a cross sectional view showing a principle of a linear electromagnetic actuator according to a fifth embodiment of the present invention; and

FIG. 12 is an exploded perspective view showing another structure example of a permanent magnet.

### DESCRIPTION OF THE PREFERRED EMBODIMENT

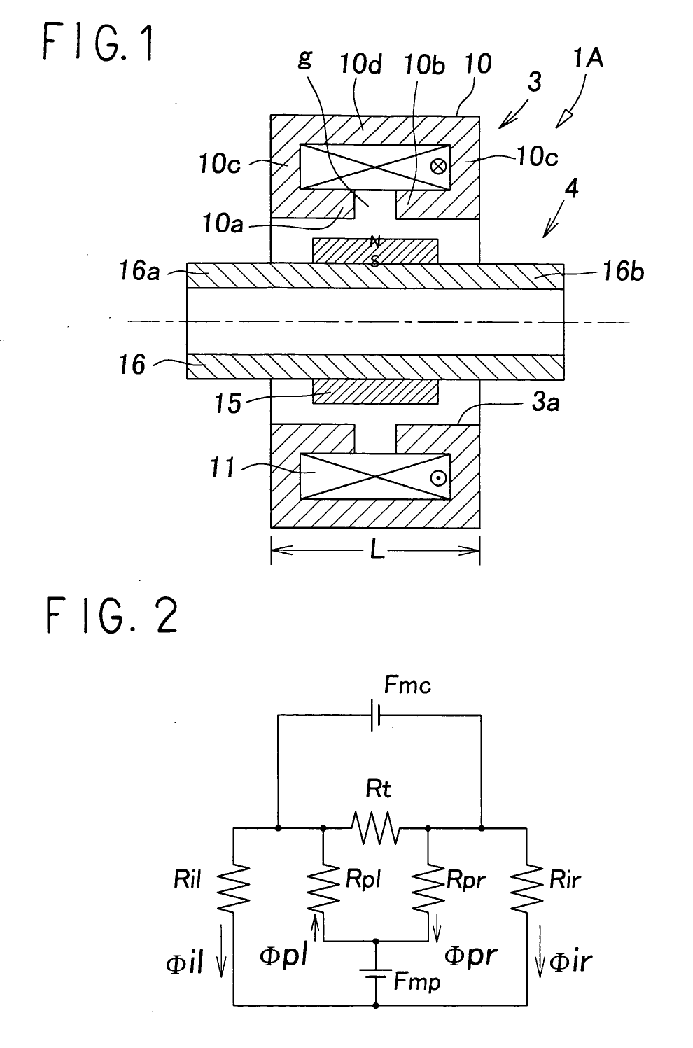

FIG. 1 shows a principle of an electromagnetic actuator according to a first embodiment of the present invention. The electromagnetic actuator 1A comprises a cylindrical electromagnet 3; and a moving object 4 which is movably fitted into a center hole 3a of the electromagnet 3 in the direction of the axis line.

The electromagnet 3 includes a fixed core 10 of a magnetic material, and one set of exciting coils 11 wound on the fixed core 10. The fixed core 10 comprises: one pair of a first pole tooth 10a and a second pole tooth 10 b, which are cylindrical and coaxially face each other through a gap g; flange-type side wall sections 10c and 10c, which extend to the outer peripheral side from the rear end section of each of the pole teeth 10a, 10b; and a cylindrical principal wall section 10d which combines the side wall sections 10c and 10c together at their outer peripheral edge, and the coil 11 is contained inside of the fixed core 10 so that the coil 11 surrounds the outer peripheries of the pole teeth 10a and 10b. The first pole tooth 10a and second pole tooth 10b have the same diameter and the same axial length and are symmetrically disposed. Moreover, the exciting coil 11 is connected to an unillustrated device, and direct voltage is applied to the coil 11.

Here, in the present invention, “magnetic material” means a material which has a property by which the material is magnetized when the material is placed in the magnetic field, but “permanent magnet” is assumed not to be included in the above material.

The object 4 includes: a cylindrical permanent magnet 15, in which the N pole and the S pole have been magnetized in the radial direction; and a cylindrical movable core 16 of a magnetic material which coaxially connected to the permanent magnet 15 and is displaced together with the magnet 15. The permanent magnet 15 has the diameter (outer diameter) larger than the diameter of the movable core 16, and the inner diameter of the permanent magnet 15 is almost equal to the outer diameter of the core 16. Moreover, the movable core 16 is of nearly uniform thickness throughout its length, and its axial length is longer than that of the permanent magnet 15. Here, the length of the movable core 16 is about three times that of the permanent magnet 15 in the present embodiment. And, the permanent magnet 15 is tightly fitted into the outer periphery of the movable core 16, and is fixed in a middle portion.

Therefore, the first core section 16a and the second core section 16b of the movable core 16 are protruded over the both sides in the direction of the axis line of the permanent magnet 15, facing the first pole tooth 10a and the second pole tooth 10b, respectively. These first core section 16a and the second core section 16b have the same axial length, which is almost equal to the length of the permanent magnet 15. Moreover, the distance between the permanent magnet 15 and the first pole tooth 10a, and that between the magnet 15 and the second pole tooth 10b are shorter than that between the first core section 16a and the first pole tooth 10a, and that between the second core section 16b and the second pole tooth 10b, respectively.

However, the first core section 16a and the second core section 16b may not necessarily have the same length as that of the permanent magnet 15, and may be longer or shorter than the length. Moreover, the both sections may be different lengths from each other.

On the other hand, comparisons between the permanent magnet 15, the movable core 16, and the fixed core 10 are performed with regard to the dimensions in the following way. That is, the axial length of the permanent magnet 15 is longer than the gap g between the pair of the pole teeth 10a and 10b, but shorter than the disposition length L of the pole teeth 10a and 10b, and the length of the movable core 16 is longer than the disposition length L of the pole teeth 10a and 10b. More particularly, the length of the permanent magnet 15 is a length covering the length between the both pole teeth 10a and 10b. Especially, the length is determined in such a way that, even when one end of the permanent magnet 15 reaches one moving end of the pole tooth 10a or 10b, the other end of the permanent magnet 15 overlaps a part of the opposite pole tooth 10b or 10a, or approaches the opposite one.

In the electromagnetic actuator 1A with the above-described configuration, when the outer peripheral side of the permanent magnet 15 is magnetized as the N pole, and the inner peripheral side of the permanent magnet 15 is magnetized as the S pole as shown in FIG. 1, a direct current flows through the exciting coil 11 in the direction shown in FIG. 1 with reference numerals to cause a state in which the first pole tooth 10a of the fixed core 10 is magnetized as the N pole, and the second pole tooth 10b of the fixed core 10 is magnetized as the S pole. Therefore, as a repulsion force acts between the N pole generated in the first pole tooth 10a and the N pole on the surface of the outer periphery of the permanent magnet 15, and, at the same time, an attraction force acts between the S pole generated in the second pole tooth 10b and the N pole of the permanent magnet 15, the interaction between these forces generates a thrust in the permanent magnet 15 in the direction of the axis line to cause a movement of the permanent magnet 15, that is, the whole moving object 4 in the center hole 3a of the fixed core 10 in the direction of the axis line (to the right side in FIG. 1).

Moreover, as the polarities of the poles generated in the two pole teeth 10a and 10b are reversed when a direct current is applied to the exciting coil 11 in the direction opposite to the direction shown in FIG. 1 with reference numerals, the direction of the thrust which acts on the permanent magnet 15 is reversed to cause a movement of the moving object 4 in the direction opposite to the above-described one, that is, to the left side in FIG. 1.

Here, as the moving object 4 includes the movable core 16 comprising a magnetic material other than the permanent magnet 15, the thrust which acts on the moving object 4 becomes larger than that only with the permanent magnet 15. This point will be sequentially explained in detail as follows.

FIG. 2 shows a magnetic equivalent circuit of the electromagnetic actuator shown in FIG. 1. Reference numerals shown in FIG. 2 will be explained as follows.
Fmc: a magnetomotive force of the exciting coil 11;
Fmp: a magnetomotive force of the permanent magnet 15;
Rt: a magnetic reluctance between the two pole teeth 10a and 10b in the fixed core 10;
Rpl: a magnetic reluctance between the first pole tooth 10a and the surface of the permanent magnet 15;
Rpr: a magnetic reluctance between the second pole tooth 10b and the surface of the permanent magnet 15;
Ril: a magnetic reluctance between the first pole tooth 10a and the first core section 16a in the movable core 16;
Rir: a magnetic reluctance between the second pole tooth 10b and the second core section 16b in the movable core 16;
φpl: a magnetic flux between the first pole tooth 10a and the permanent magnets 15;
φpr: a magnetic flux between the second pole tooth 10b and the permanent magnets 15;
φil: a magnetic flux between the first pole tooth 10a and the first core section 16a in the movable core 16;
φir: a magnetic flux between the second pole tooth 10b and the second core section 16b in the movable core 16.

Here, when there is no movable core 16, a force F which acts on the moving object 4 by magnetic fluxes generated between the moving object 4 (accordingly, the permanent magnet 15) and the first pole tooth 10a, and between the object 4 and the second pole tooth 10b is given by the following formula (1). In this case, the left side in FIG. 1 is assumed to be positive.
F∝φpr²−φpl² (1)

Moreover, even when a fixed back core (refer to “back yoke” in JP-A2002-101631), instead of the movable core 16, is fixed at a fixed position, the force F which acts on the moving object is expressed by the same formula as the formula (1). The reason is, even when the magnetic fluxes φir and φil are generated between the first pole tooth 10a and a first core section of the fixed back core, and between the second pole tooth 10b and a second core section of the back core, respectively, no force acts as a thrust on the moving object by the magnetic fluxes.

And, when the moving object 4 has the movable core 16, and the core 16 is displaced together with the permanent magnet 15 as in the first embodiment, the force F which acts on the moving object 4 is given by the following formula (2).
F∝φpr²+φil²−φpl²−φir (2)

The φpr² and φpl² are forces which act on the permanent magnet 15 by magnetic fluxes which are generated between the permanent magnet 15 and the first pole tooth 10a, and between the magnet 15 and the second pole tooth 10b, respectively. The (φil² and φir² are forces which act on the moving core 16 by magnetic fluxes which are generated between the movable core 16 and the first pole tooth 10a, and between the core 16 and the second pole tooth 10b, respectively.

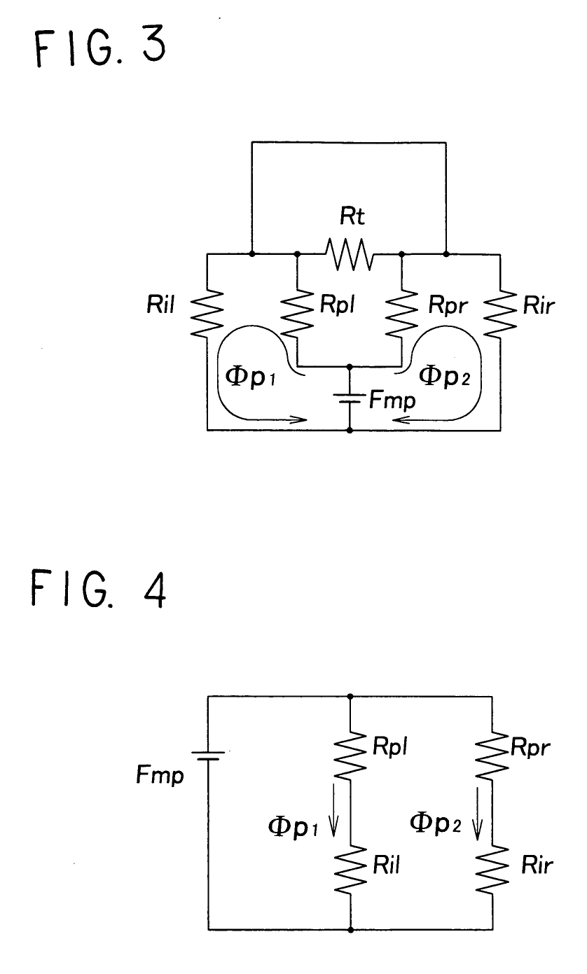

Now, when a current flowing in a non-energized state of the exciting coil 11 is 0A as shown in FIG. 3, the magnetic fluxes φp₁ and φp₂ are generated by the magnetomotive force of the permanent magnet 15 in a circuit in FIG. 3. As the circuit in FIG. 3 can be rewritten as shown in FIG. 4, the magnetic fluxes φp₁ and φp₂ are obtained as the following formulae (3) and (4):
φp₁=Fmp/(Rpl+Ril) (3)
φp₂=Fmp/(Rpr+Rir) (4)

Here, for example, when the permanent magnet 15 is at the center of symmetry (neutral position), the following formulae are obtained:
Rpl=Rpr (5)
Ril=Rir (6)

Then, φp₁=φp₂ is derived from the formulae (3) and (4). Accordingly, it can be understood from the above formulae (1) and (2) that no force acts on the moving object 4.

However, as the formulae (5) and (6) do not hold true when the permanent magnet 15 is not at the center of symmetry, a force acts on the moving object 4 to cause a holding force.

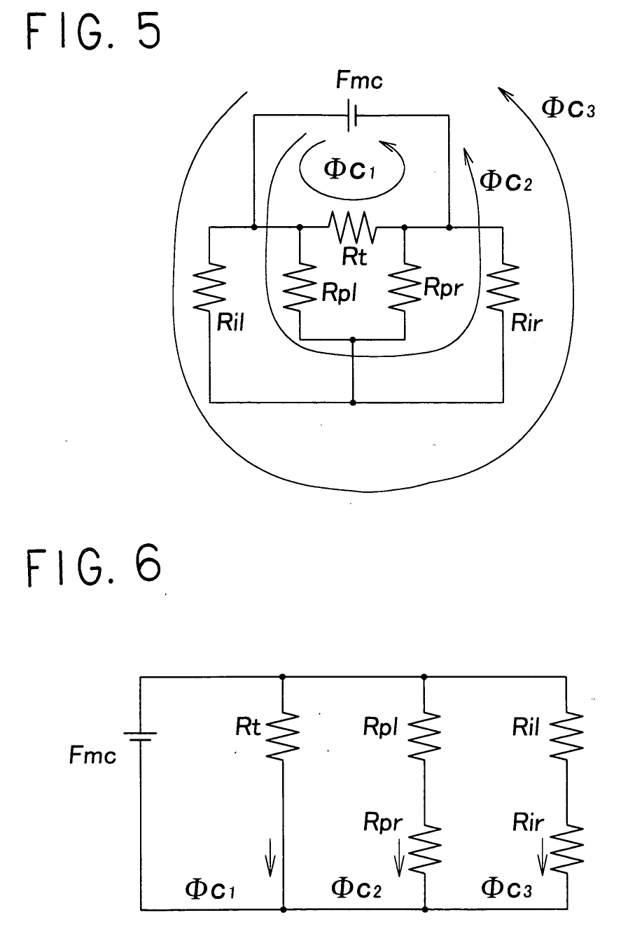

Then, when a current flows through the exciting coil 11, magnetic fluxes φc₁, φc₂, and φc₃ caused by the current are generated in the electromagnetic actuator as shown in FIG. 5. As the circuit in FIG. 5 can be rewritten as shown in FIG. 6, the magnetic fluxes φc₁, φc₂, and φc₃ are obtained as the following formulae (7), (8), and (9):
φc₁=Fmc/Rt (7)
φc₂=Fmc/(Rpl+Rpr) (8)
φc₃=Fmc/(Ril+Rir) (9)

Then, the following formulae (10), (11), (12), and (13) are obtained by the principle of superposition:
φpl=φp₁−φc₂ (10)
φil=φp₁−c₃ (11)
φpr=φp₂+φc₂ (12)
φir=φp₂+φc₃ (13)

Here, when there is no movable core 16, a force which acts on the moving object 4 (the permanent magnet 15) is obtained as follows by substituting the formulae (10) and (12) for the formula (1):

$$\begin{matrix}F ∝ ϕ {pr}^{2} - ϕ {pl}^{2} = ϕ {p}_{2}^{2} + 2 ϕ {p}_{2} \cdot ϕ {c}_{2} + ϕ {c}_{2}^{2} - ( ϕ {p}_{1}^{2} - 2 ϕ {p}_{1} \cdot ϕ {c}_{1} + {ϕ}_{2}^{2} ) \\ = 2 ϕ {c}_{2} ( ϕ {p}_{1} + ϕ {p}_{2} )\end{matrix} \qquad ( 14 )$$

Moreover, as the magnetic reluctances Ril and Rir are small between the first core section of the fixed back core and the first pole tooth 10a, and between the second core section of the fixed back core and the second pole tooth 10b, respectively, when there is the fixed back-core, which does not move, inside the permanent magnet 15, the magnetic fluxes φp₁ and φp₂ become larger in the formula (14) to make the force F which acts on the moving object 4 larger than that of a case without the fixed back core.

And, when the moving object 4 has the movable core 16 which is displaced together with the permanent magnet 15 as in the above-described embodiment, the force including φil² and φir² acts on the movable core 16 by the magnetic fluxes generated between the movable core 16 and the first pole tooth 10a and between the core 16 and the second pole tooth 10b as shown in the formula (2). Moreover, as the changes in the formulae (11) and (12) are in proportion to φc₃ (accordingly, in inverse proportion to Ril and Rir), it is understood that the force F which acts on the whole moving object 4 becomes further larger than that of a case without the fixed back core. Moreover, the closer the movable core 16 gets to the first or the second pole tooth 10a or 10b, the smaller the magnetic reluctance Ril or Rir becomes between the core 16 and the first pole tooth 10a or between the core 16 and the second one 10b. Accordingly, the thrust becomes larger. Thus, as the moving object 4 has the movable core 16 of a magnetic material, other than the permanent magnet 15, the thrust which acts on the moving object 4 becomes much larger than that of a case only with the permanent magnet 15 to cause a larger stroke along with the larger thrust.

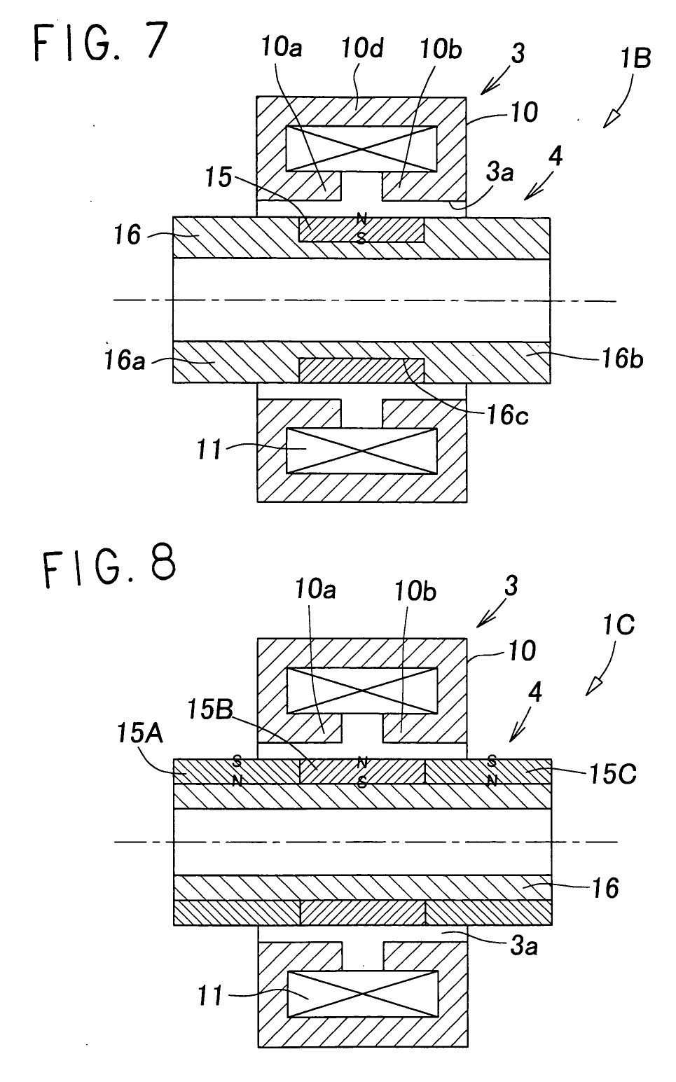

FIG. 7 shows an electromagnetic actuator according to a second embodiment of the present invention. In the electromagnetic actuator 1B, a concave groove 16c in the circumferential direction is formed so that the groove 16c faces pole teeth 10a and 10b on the surface of the outer periphery of a movable core 16, and a permanent magnet 15 is fitted into and fixed in the concave groove 16c. Though the outer diameter of the permanent magnet 15 may be larger than that of the movable core 16, the diameter is formed to be almost equal to that of the movable core 16 in the shown example. Accordingly, the surface of the outer periphery of the permanent magnet 15, and that of the outer peripheries of a first core section 16a and a second core section 16b of the movable core 16 are located substantially on the same circumferential surface.

As other portions of the second embodiment are substantially the same as those of the first embodiment, the same reference numerals as those in the first embodiment are applied to the same portions, and the description of the same portions will be omitted.

As the surface of the outer periphery of the permanent magnet 15, and that of the outer peripheries of the both core sections 16a and 16b of the movable core 16 are located on the same circumferential surface in the second embodiment, magnetic reluctances Ril between the first core section 16a and the first pole tooth 10a, and Rir between the second core section 16b and the second pole tooth 10b are small than Ril and Rir in the first embodiment, respectively. Accordingly, as magnetic fluxes φp₁, and φp₂, which are generated between them, become larger, a force F which acts on the moving object 4 becomes further larger than that of the first embodiment.

FIG. 8 shows an electromagnetic actuator according to a third embodiment of the present invention. The electromagnetic actuator 1C is different from the electromagnetic actuator 1A of the first embodiment in that a moving object 4 has a plurality of permanent magnets 15A, 15B, and 15C, and the permanent magnets 15A, 15B, and 15C are continuously provided on the outer periphery of a movable core 16 in the direction of the axis line. That is, the plurality of the permanent magnets 15A, 15B, and 15C has been provided for one set of exciting coils 11 and one pair of pole teeth 10a and 10b in the third embodiment. Two kinds of permanent magnets which are different from each other in the direction of magnetization for the N pole or the S pole are used for the plurality of the permanent magnets, and these two kinds of permanent magnets are alternately disposed in the direction of the axis line. In the example shown in the drawing, the first through the third permanent magnets, 15A, 15B, and 15C are used, and the direction of magnetization for the first and third permanent magnets 15A and 15C, which are located at the both end sides, respectively, and that for the second permanent magnet 15B located between the two magnets 15A and 15C are opposite to each other with regard a relation between the inside and the outside. The outer diameters and the lengths for these three permanent magnets 15A, 15B, and 15C are the same, and the total length of these three permanent magnets and the length of the movable core 16 are substantially the same.

As other portions of the present third embodiment are substantially the same as those of the first embodiment, the same reference numerals as those in the first embodiment are applied to the same portions, and the description of the same portions will be omitted.

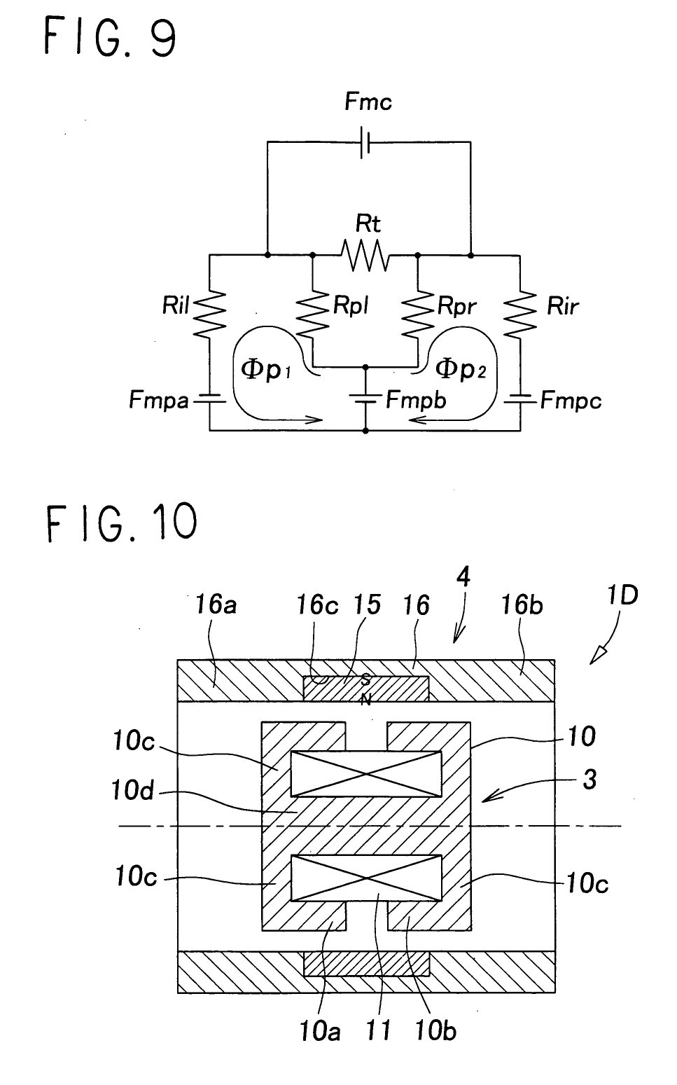

In FIG. 9 showing a magnetic equivalent circuit of the electromagnetic actuator 1C according to the third embodiment, larger magnetic fluxes φp₁ and φp₂ can be generated by magnetomotive forces Fmpa, Fmpb, and Fmpc in each of the three permanent magnets 15A, 15B, and 15C. Accordingly, a force F which acts on the moving object 4 becomes further larger than the forces of the first and the second embodiments.

FIG. 10 shows an electromagnetic actuator according to a fourth embodiment of the present invention. A difference between this electromagnetic actuator 1D and the electromagnetic actuator 1B of the second embodiment is that though the second embodiment has one pair of pole teeth 10a and 10b in the fixed core 10 provided on the inner peripheral side of the exciting coil 11 and the moving object 4 fitted into the inside of these pole teeth 10a and 10b, the fourth embodiment has one pair of pole teeth 10a and 10b in a fixed core 10 provided in the outer peripheral side of an exciting coil 11 and a moving object 4 fitted into the outside of these pole teeth 10a and 10b. In other words, the diameter of the moving object 4 is formed to be larger than that of an electromagnet 3, and the electromagnet 3 is fitted into the inside of the moving object 4. Accordingly, the moving object 4 has a configuration in which a concave groove 16c in the circumferential direction is formed so that the groove 16c faces pole teeth 10a and 10b on the region of the inner periphery of a movable core 16; a permanent magnet 15 is fitted into and fixed in the concave groove 16c; and the surface of the inner periphery of the permanent magnet 15, and that of the inner periphery of a first core section 16a and a second core section 16b of the movable core 16 are located on the same circumferential surface.

As other portions of the present fourth embodiment are substantially the same as those of the second embodiment, the same reference numerals as those in the second embodiment are applied to the same portions, and the description of the same portions will be omitted. Here, the permanent magnet 15 can be provided so that the magnet 15 is protruded over the inner side from the inner peripheral surface of the movable core 16, and this configuration and that of the first embodiment are opposite to each other with regard a relation between the inside and the outside.

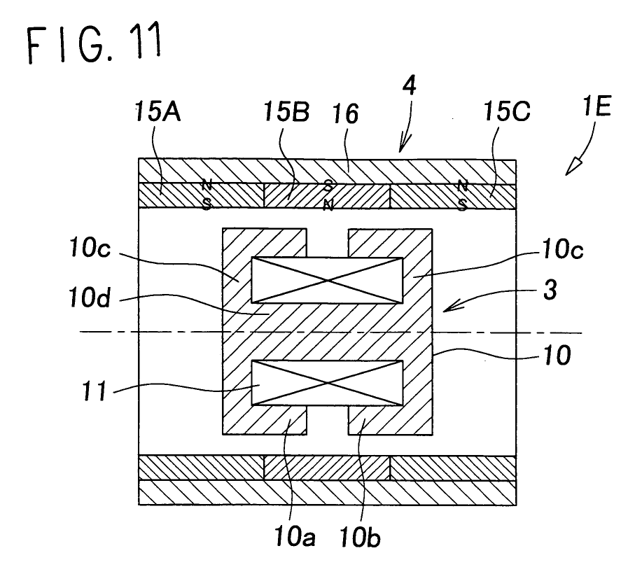

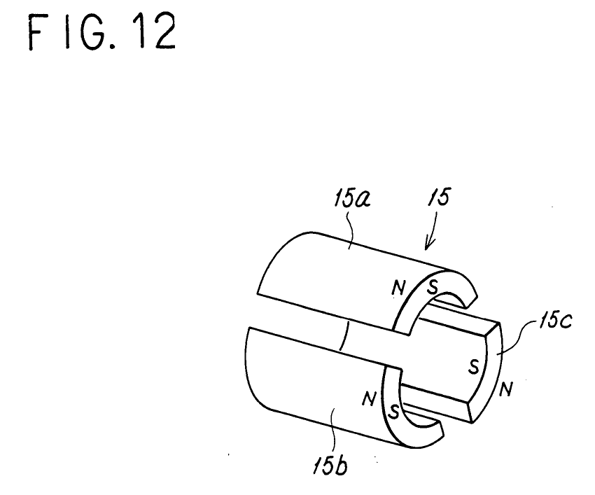

FIG. 11 shows an electromagnetic actuator according to a fifth embodiment of the present invention. This electromagnetic actuator 1E is different from the electromagnetic actuator 1D of the fourth embodiment in that a moving object 4 has a plurality of (three pieces of) permanent magnets 15A, 15B, and 15C, and these permanent magnets are continuously provided on the inner periphery of a movable core 16 in the direction of the axis line. However, other portions of the fifth embodiment with regard to the following points are the same as those of the third embodiment: two kinds of permanent magnets which are different from each other in the direction of magnetization for the N pole or the S pole are used for the permanent magnets, and these two kinds of permanent magnets are alternately disposed in the direction of the axis line; the outer diameters and the lengths for these three permanent magnets 15A, 15B, and 15C are the same, and the total length of these three permanent magnets and the length of the movable core 16 are substantially the same; and the plurality of the permanent magnets 15A, 15B, and 15C are provided for one set of exciting coils 11 and one pair of pole teeth 10a and 10b.

As other portions of the present fifth embodiment are substantially the same as those of the fourth embodiment, the same reference numerals as those in the fourth embodiment are applied to the same portions, and the description of the same portions will be omitted.

Here, though each of the cylindrical permanent magnets 15, 15A, 15B, and 15C used in the above-described embodiments are completely integrated into one body, each of them may be divided into a plurality of magnet pieces. FIG. 12 shows one example of such a permanent magnet with divided magnet pieces. The permanent magnet 15 (or 15A, 15B, and 15C) comprises three magnet pieces 15a, 15b, and 15c with arc-shaped cross sections, and is formed to be a cylindrical body by combining the magnet pieces. Moreover, the permanent magnet can be divided into two or four magnet pieces, or more than four magnet pieces. Furthermore, when the magnet pieces 15a, 15b, and 15c are combined into a cylindrical body, they may be bonded into one body with an adhesive and the like, or may be left unbonded. Moreover, each of the magnet pieces may be obtained by equally dividing a cylindrical body, or by unequally dividing the body. Or, these magnet pieces may be disposed into a cylindrical body by making arc lengths of the magnet pieces 15a, 15b, and 15c a little shorter than the length of the magnet piece obtained by equally dividing the cylindrical body, and by keeping them with little gaps.

1. A linear electromagnetic actuator comprising:
a fixed core of a magnetic material provided with one pair of pole teeth, which cylindrical and coaxially face each other through a gap;
exciting coils wound on the fixed core; and
a moving object which is movably disposed in the direction of the axis line coaxially with the pole teeth, wherein
the moving object includes: one or more permanent magnets formed integrally in a cylindrical shape or formed by cylindrically disposing a plurality of magnet pieces of arc-shaped cross section, in which the N pole and the S pole have been magnetized in the radial direction; and a cylindrical movable core of a magnetic material which is coaxially connected to the permanent magnet and is displaced together with the magnet.

2. The electromagnetic actuator according to claim 1, wherein
the pair of pole teeth in the fixed core are provided on the inner peripheral side of the exciting coils; the moving object is fitted into the inside of the pole teeth; and the permanent magnet is connected to the moving object so that the permanent magnet faces the pole teeth on the region of the outer periphery of the movable core.

3. The electromagnetic actuator according to claim 1, wherein
the pair of pole teeth in the fixed core are provided on the outer peripheral side of the exciting coils; the moving object is fitted into the outside of the pole teeth; and the permanent magnet is connected to the moving object so that the permanent magnet faces the pole teeth on the region of the inner periphery of the movable core.

4. The electromagnetic actuator according to any one of claims 1 to 3, wherein
the axial lengths of each of the permanent magnets are shorter than the disposition length of the pair of pole teeth, and the axial length of the movable core is longer than either of the length of each of the permanent magnets or the disposition length of the pair of pole teeth.

5. The electromagnetic actuator according to any one of claims 1 to 3, wherein
the moving object has one permanent magnet; a concave groove in the circumferential direction is formed on the movable core so that the groove faces the pole teeth; the permanent magnet is fitted into the concave groove; and the circumferential surface of the permanent magnets, and that of the movable core, which are facing the pole teeth, are located on the same circumferential surface.

6. The electromagnetic actuator according to claim 4, wherein
the moving object has one permanent magnet; a concave groove in the circumferential direction is formed on the movable core so that the groove faces the pole teeth; the permanent magnet is fitted into the concave groove; and the circumferential surface of the permanent magnets, and that of the movable core, which are facing the pole teeth, are located on the same circumferential surface.

7. The electromagnetic actuator according to any one of claims 1 to 3, wherein
the moving object comprises two kinds of permanent magnets which are different from each other in the direction of magnetization for the N pole or the S pole, and the two kinds of permanent magnets are plurally alternately disposed in the direction of the axis line.

8. The electromagnetic actuator according to claim 4, wherein
the moving object comprises two kinds of permanent magnets which are different from each other in the direction of magnetization for the N pole or the S pole, and the two kinds of permanent magnets are plurally alternately disposed in the direction of the axis line.

9. The electromagnetic actuator according to claim 1, wherein
the moving object includes three permanent magnets.

10. The electromagnetic actuator according to claim 9, wherein
the total length of the plurality of permanent magnets and the length of the movable core are substantially the same.
